(19) United States
(12) Patent Application Publication
(10) Pub. No.: US 2025/0119901 A1
(43) Pub. Date: Apr. 10, 2025

(54) SYSTEMS AND METHODS FOR ADJUSTING CARRIER CHANNELS

(71) Applicant: CORNING RESEARCH & DEVELOPMENT CORPORATION, Corning, NY (US)

(72) Inventors: Syed Noman Ahmad, San Jose, CA (US); Swami Dayal Srivastava, Milpitas, CA (US); Gourav Wadhawa, Fremont, CA (US)

(21) Appl. No.: 18/377,070

(22) Filed: Oct. 5, 2023

(51) Int. Cl. H04W 72/1263; H04W 28/02; H04W 88/08

(52) U.S. Cl. CPC H04W 72/1263; H04W 28/0252; H04W 88/085

(57) ABSTRACT

Systems and method for adjusting carrier channels are disclosed. In one aspect, a number of carrier channels scheduled by a radio node (RN) is adjusted based on how many user equipment (UE) are being served by the RN. In this manner, during moments of heavy traffic, the scheduler can throttle use of the carrier channels to assist in meeting the radio transmission time-interval. By helping meet the radio transmission time-interval disconnection of the UEs may be reduced, improved throughput may be achieved, and overall stability of the RN improved.

### BACKGROUND

The technology of the disclosure relates generally to a radio node (RN) that serves user equipment (UE) in a wireless communication system (WCS).

Computing devices abound in modern society, and more particularly, mobile communication devices have become increasingly common. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences. With the proliferation of mobile communication devices, there has been pressure to make sure that these devices readily have a way to connect to a wireless network to facilitate data exchange. This pressure has led to an evolution in the available cellular standards as well as the proliferation of auxiliary wireless networks that help extend wireless service to areas underserved by traditional commercial cellular networks. Optimization of these auxiliary networks leads to opportunities for innovation, and in some cases, the optimization may be extended to the traditional commercial cellular networks.

No admission is made that any reference cited herein constitutes prior art. Applicant expressly reserves the right to challenge the accuracy and pertinency of any cited documents.

### SUMMARY

Aspects disclosed in the detailed description include systems and methods for adjusting carrier channels. In particular, aspects of the present disclosure contemplate adjusting a number of carrier channels scheduled by a radio node (RN) based on how much user equipment (UE) is being served by the RN. In this manner, during moments of heavy traffic, the scheduler can throttle the use of the carrier channels to assist in meeting the radio transmission time interval. By helping meet the radio transmission time interval disconnection of the UEs may be reduced, improved throughput may be achieved, and overall stability of the RN improved.

In this regard in one aspect, an RN is disclosed. The RN includes an interface configured to communicate wirelessly with user equipment. The RN further includes a control circuit coupled to the interface and configured to evaluate a number of active user equipment and throttle carrier channel scheduling based on the number of active user equipment.

In another aspect, a method of adjusting carrier channels is disclosed. The method includes determining a number of active user equipment associated with an RN and throttling carrier channel scheduling when the number of active user equipment exceeds a threshold.

In another aspect, a wireless communication system (WCS) is disclosed. The WCS includes an RN that includes an interface configured to communicate wirelessly with user equipment. The WCS RN further includes a control circuit coupled to the interface and configured to evaluate a number of active user equipment and throttle carrier channel scheduling based on the number of active user equipment.

### BRIEF DESCRIPTION OF THE DRAWINGS

FIG. 1 is a schematic diagram of an exemplary wireless communication system (WCS) implemented as a Radio Access Network (RAN) that includes a conventional single-operator radio node that includes a massive antenna array (MAA) to support distribution of communications signals to a user device;

FIGS. 2A and 2B are examples of Open-standard RANs (O-RANs);

FIG. 3 is a block diagram of a radio node (RN) of the WCS of FIG. 1 with additional details of the internal elements;

FIG. 4 is a block diagram of the media access control (MAC) layer of the RN of FIG. 3;

FIG. 5 is a flowchart of a process for adjusting carrier channels based on how much user equipment (UE) is associated with the RN;

FIG. 6 is a flowchart expanding on a step for configuring the RN for channel adjustment in the process of FIG. 5;

FIG. 7 is a flowchart expanding on a step for determining a number of active UE in the process of FIG. 5;

FIG. 8 is an exemplary RAN system that includes multiple O-RANs that are configured to support different service providers and that are each configured to directly interface with a shared modified Open-standard remote unit (O-RU);

FIG. 9 is an exemplary RAN system that includes multiple RANs (e.g., O-RANs) implemented according to a RAN standard (e.g., O-RAN standard), wherein each RAN is configured to support a different service provider, and wherein each RAN has a distribution unit (DU) configured to interface with a shared remote unit (RU) through an intermediary neutral host agent device that has a transparent interface to the DUs and shared RU;

FIG. 10 is a schematic diagram of the exemplary division of components and communications layers between devices in an O-RAN in the RAN system in FIG. 9; and

FIG. 11 is a schematic diagram providing an exemplary illustration of the computing devices in the WCS of FIG. 7.

### DETAILED DESCRIPTION

Aspects disclosed in the detailed description include systems and methods for adjusting carrier channels. In particular, aspects of the present disclosure contemplate adjusting a number of carrier channels scheduled by a radio node (RN) based on how much user equipment (UE) is being served by the RN. In this manner, during moments of heavy traffic, the scheduler can throttle the use of the carrier channels to assist in meeting the radio transmission time interval. By helping meet the radio transmission time interval disconnection of the UEs may be reduced, improved throughput may be achieved, and overall stability of the RN improved.

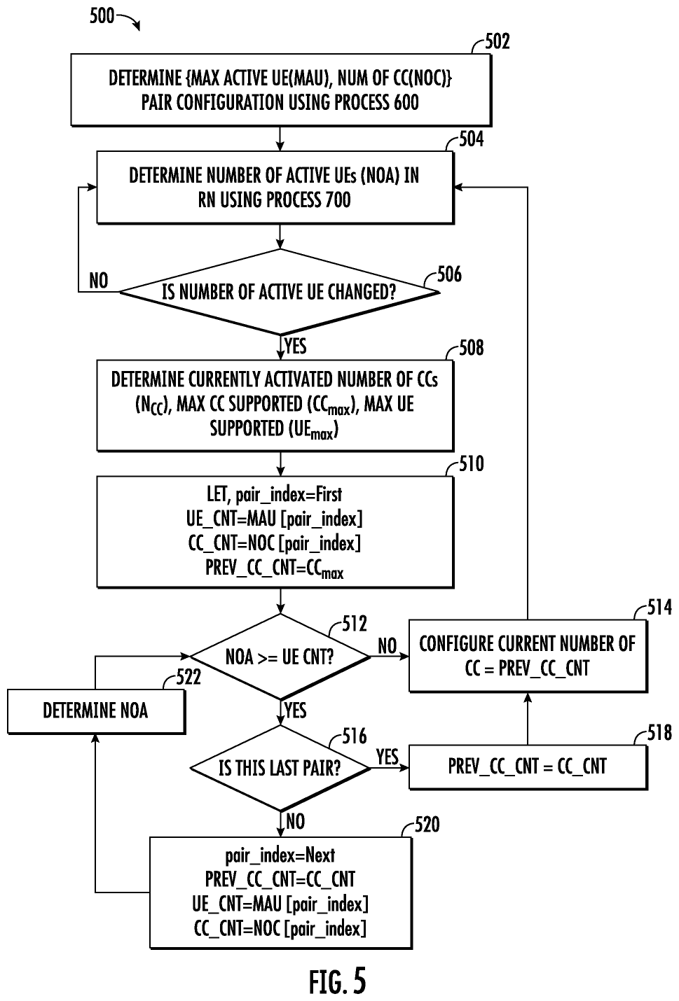

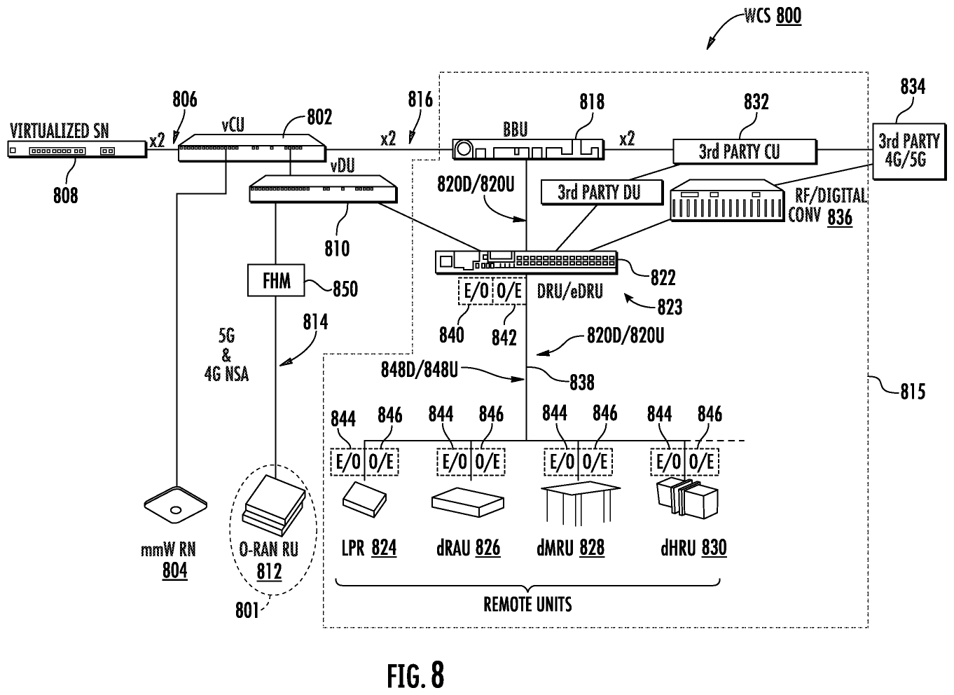

Before addressing exemplary aspects of the present disclosure, an overview of a wireless communication system (WCS) with a RN is described followed by more details about the structure of the RN to provide context for the present disclosure. A discussion of exemplary aspects of the present disclosure begins below with reference to FIG. 5. A more holistic exploration of various WCS topologies begins below with reference to FIG. 8.

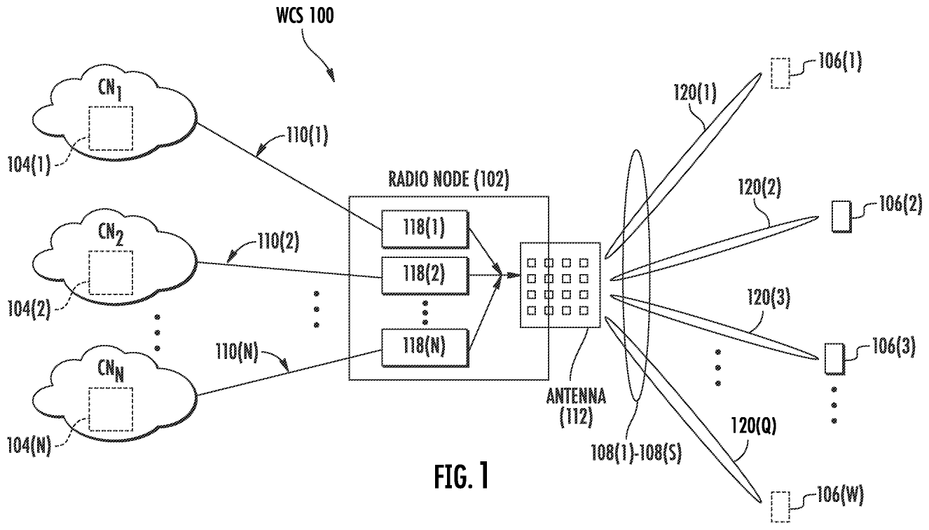

In this regard, FIG. 1 is an example of a WCS 100 that includes a RN 102 configured to support one or more service providers SP₁-SP_{N}, 104(1)-104(N) as signal sources (also known as “carriers” or “service operators”—e.g., mobile network operator (MNO)) and wireless client devices 106(1)-106(W). For example, the RN 102 in the WCS 100 in FIG. 1 can be a small cell RAN (“small cell RAN”) that is configured to support multiple service providers 104(1)-104(N) by distributing a communications signal stream 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. In an exemplary aspect, an antenna 112 may be used to send the signals to the wireless client devices 106(1)-106(W). The antenna 112 may be an antenna array. The RN 102 includes radio circuits 118(1)-118(N) for each service provider 104(1)-104(N) that are configured to create multiple simultaneous RF beams (“beams”) 120(1)-120(Q) for the communications signal streams 108(1)-108(S) to serve multiple wireless client devices 106(1)-106(W). For example, the multiple RF beams 120(1)-120(Q) may support multiple-input, multiple-output (MIMO) communications.

Small cells can support one or more service providers in different channels within a frequency band to avoid interference and reduced signal quality as a result. Secure communications tunnels are formed between the wireless client devices 106(1)-106(W) and the respective service provider 104(1)-104(N). Thus, in this example, the RN 102 essentially appears as a single node (e.g., eNB in 4G or gNB in 5G) to the service provider 104(1)-104(N).

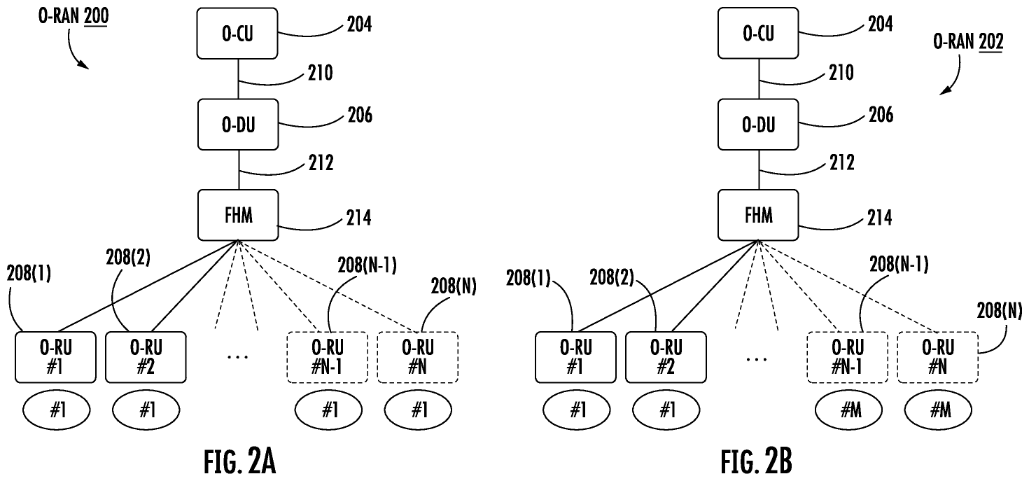

Open-RAN (O-RAN) is a set of specifications that specifies multiple options for functional divisions of a cellular base station between physical units, and it also specifies the interface between these units. An example of a possible division specified by O-RAN is in the O-RANs 200, 202 is shown in FIGS. 2A and 2B, respectively. In the O-RANs 200, 202, the functionality of the base station (e.g., gNB, as called in the context of 5G) is divided into three functional units of an O-RAN central unit (O-CU) 204, an O-RAN distribution unit (O-DU) 206, and one or more O-RAN remote units (O-RUs) 208(1)-208(N). These components may run on different hardware platforms and reside at different locations. The O-RUs 208(1)-208(N) include the lowest layers of the base station, and it is the entity that wirelessly transmits and receives signals to user devices. The O-CU 204 includes the highest layers of the base station and is coupled to a “core network” of the cellular service provider. The O-DU 206 includes the middle layers of the base station to provide support for a single cellular service provider (also known as operator or carrier). An F1 interface 210 is connected between the O-CU 204 and the O-DU 206. An eCPRI/O-RAN fronthaul interface 212 connects the O-DU 206 and an O-RU 208. The F1 interface 210 and eCPRI/O-RAN fronthaul interface 212 use Ethernet protocol for conveying the data in this example. Therefore, Ethernet switches (not shown in FIGS. 2A and 2B) may exist between the O-CU 204 and the O-DU 206 and between the O-DU 206 and the O-RU 208.

Each O-DU 206 can also be coupled to a single or to a cluster of O-RUs 208(1)-208(N) that serve signals of the one or more “cells” of the O-DU 206. A “cell” in this context is a set of signals intended to serve subscriber units (e.g., cellular devices) in a certain area. Multiple O-RUs 208(1)-208(N) are supported in the O-RAN by what is referred to as a “Shared-Cell.” Shared-Cell is realized by a front-haul multiplexer (FHM) 214, placed between the O-DU 206 and the O-RUs 208(1)-208(N). The FHM 214 de-multiplexes signals from the O-DU 206 to the plurality of O-RUs 208(1)-208(N) and multiplexes signals from the plurality of O-RUs 208(1)-208(N) to O-DU 206. The FHM 214 can be considered as an O-RU with front haul support and additional copy-and-combine function but lacks the radio frequency (RF) front-end capability. The O-RAN 200 in FIG. 2A shows the O-RUs 208(1)-208(N) supporting the same cell (#1). The O-RAN 202 in FIG. 2B shows each O-RU 208(1)-208(N) supporting the different cell (#1 . . . #M). In each case the O-RANs 200, 202 in FIGS. 2A and 2B, and the O-DU 206 provide support for a single cellular service provider to provide cell services to the plurality of O-RUs 208(1)-208(N).

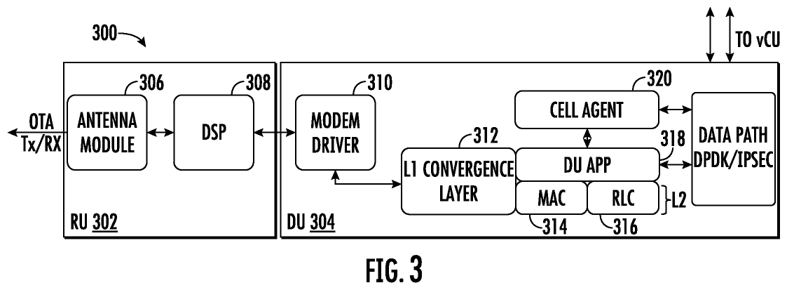

Radio nodes of a new radio (NR) millimeter wave (mmWave) that comply with the standards published by the Third Generation Partnership Project (3GPP) may be relatively small equipment that houses a radio unit (RU) and a distributed unit (DU). An exemplary radio node 300 is illustrated in FIG. 3. In this regard, the radio node 300 includes an RU 302 and a DU 304. The RU 302 may include an antenna module 306 and a digital signal processor (DSP) 308. The DU 304 may include a modem driver 310, an L1 convergence layer 312, a media access control (MAC) layer circuit 314 (generally in the L2 layer), a radio link control (RLC) layer circuit 316, a DU app circuit 318, and a cell agent 320, which may collectively reside in an ARM processor or the like. Exemplary aspects of the present disclosure reside in the MAC layer circuit 314, and accordingly, the MAC layer circuit 314 may be configured to perform aspects of the present disclosure. The DU 304 interacts with the CU (not shown in FIG. 3) for control plane messages like cell (re) configuration, UE (re) configuration, or the like.

In general, the radio node has limited processing and memory capabilities. When there are a large number of UE to be served that are using high or maximum uplink and bandwidth throughput such that a maximum number of carrier channels are in use for each UE, the combined load may, in effect, overload the processor of the DU. The overloaded processor may overshoot the maximum radio transmission time interval. This situation leads to a reduction of throughput, and possible disconnection of UEs, and negatively impacts the stability of the radio node. While merely improving the processor is one solution, this approach is generally commercially impractical as the increased cost is not tolerated by the end user.

Exemplary aspects of the present disclosure contemplate providing the ability for the MAC layer circuit 314 to throttle the carrier channels used by the UEs at instantaneous peak loads by using the scheduling capability to schedule fewer carrier channels. This reduction in the scheduling of carrier channels still allows signals to be sent and received but slows the overall throughput enough to avoid overshooting the radio transmission time interval. Then, when congestion eases, the scheduler may resume use of more carrier channels.

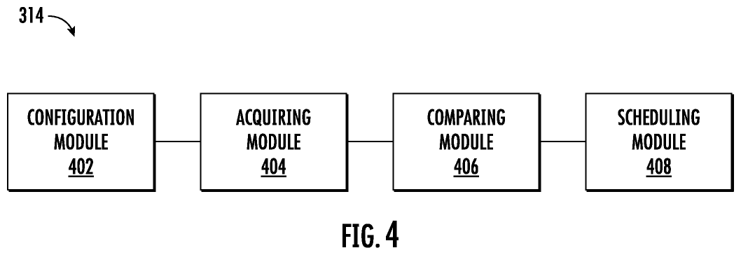

More details of the MAC layer circuit 314 are provided in FIG. 4. In this regard, the MAC layer circuit 314 may include a configuration module 402, an acquiring module 404, a comparing module 406, and a scheduling module 408. The configuration module 402 accepts configuration of a maximum number of active UE and a number of carrier channels from telecom operators. These numbers may be paired and stored in memory (not shown). The acquiring module 404 may acquire a value of active UE and a number of carrier channels currently used for scheduling as better explained below. The comparing module 406 will compare a maximum number of active UE with the configuration values and trigger a change to the number of carrier channels when appropriate. The scheduling module 408 may decide a number of carrier channels based on the number of active UE. Note that this decision is based on instantaneous load so as to address peak loads and then return to a default setting when the peak has passed.

As noted, the MAC layer circuit 314 provides a process 500 illustrated in FIG. 5 that throttles the carrier channels based on how many UEs are active. In particular, the MAC layer circuit 314 does not change configuration and does not tell the UE that there are fewer carrier channels than expected. Rather, the MAC layer circuit 314 merely does not schedule one or more carrier channels during the throttle window. Then, once the congestion has passed and there are fewer active UEs, the MAC layer circuit 314 may begin scheduling for more carrier channels. In this fashion, the timing requirements are more likely to be met and stability of the radio node 300 improved.

To assist in knowing when to throttle, the MAC layer circuit 314 may use the concept of an active UE/number of carrier channel pair. This pair is, in essence, two numbers, where the second number identifies the number of carrier channels used so long as the number of active UE exceeds the first number. By way of example, for a radio node 300 that supports up to sixty-four (64) UE with four (4) carrier channels, four pairs may be defined: {0,4; 16,3; 32,2, 48,1}. Thus, if 0-15 UE are active, all four carrier channels are used; if 16-31 UE are active, three carrier channels are scheduled; if 32-47 UE are active, two carrier channels are used; and once 48 or more UE are active, only 1 carrier channel is used. Note that the first pair may be implicitly defined by being bounded by the second pair. That is, the second pair necessarily defines all the variables of the first pair, so it may not be necessary to define the first pair explicitly. This pairing may be abstracted by assuming that there are Y carrier channels and X=(total possible number of active UE)/Y. Thus, the pairs will be {0,Y; X,Y−1; 2X,Y−2; . . . (Y−1)X,1}.

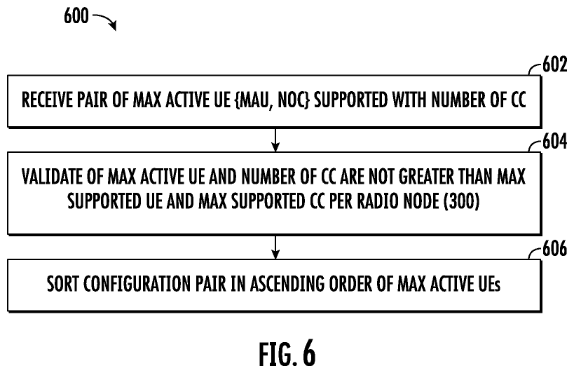

The process 400 begins by creating the pair configurations, where each pair can be defined as a {maximum number of active UE (MAU), number of carrier channel (NOC)} using a process 600 (block 502). The process 600 is set forth with reference to FIG. 6.

Turning to FIG. 6, the process 600 begins by receiving a pair {MAU, NOC} (block 602). The pair is validated by comparing to a maximum possible supported UE and maximum possible supported carrier channel per radio node 300 (block 604). The pairs are then sorted in ascending order of MAU (block 606).

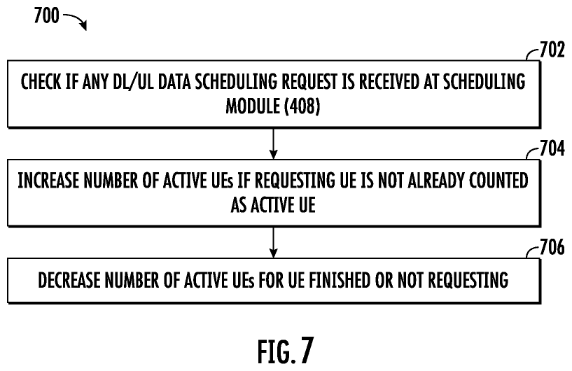

Returning to the process 500 in FIG. 5, the radio node 300 determines a number of active UEs (NOA) in the radio node 300 using a process 700 (block 504). The process 700 is set forth with reference to FIG. 7. Note that this determination is an instantaneous determination, not a time-averaged or cumulative determination. Note further, a UE is considered “active” in this context when the UE is consistently getting wireless channel resources allocated for uplink or downlink data flow, and does not include UE that are merely connected or registered with the radio node 300 with the exchange of periodic link maintenance signaling messages only.

Turning to FIG. 7, process 700 begins by checking if any downlink or uplink data scheduling request is received at the scheduling module 408 (block 702). The scheduling module 408 increases a number of active UEs if a requesting UE is not already counted as an active UE (block 704). Additionally, the scheduling module 408 may decrease the number of active UE for any UE finished with a data stream or not actively seeking an uplink scheduling request (block 706).

Returning to the process 500 in FIG. 5, the MAC layer circuit 314 determines if the number of active UE has changed (block 506). If the answer to block 506 is no, the number is unchanged, the process returns to block 504. Once the answer to block 506 is yes, the number has changed, then the MAC layer circuit 314 determines a currently activated number of carrier channels (N_{CC}), a maximum number of carrier channels supported (CCₘₐₓ), and a maximum number of UE supported (UEₘₐₓ) (block 508). Note that some of this information may be preloaded during manufacturing or acquired earlier.

The MAC layer circuit 314 sets a pair_index at FIRST, sets a UE count (UE_CNT)=MAU [pair_index], sets a carrier channel count (CC_CNT)=NOC[pair_index] and sets the previous carrier channel count (PREV_CC_CNT)=CCₘₐₓ (block 510). The MAC layer circuit 314 then determines if the number of active UE (NOA) is greater than or equal to the UE_CNT (block 512). This step is checking to see if the number of active UE has passed the first number in the pair (e.g., has the number of UE equaled or exceeded 16 using the example above). If the answer to block 512 is no, then the MAC layer circuit 314 configures the current number of carrier channels to be the previous carrier channel count (PREV_CC_CNT) (block 514). Thus, for example, the first time block 512 is negative, the current number of carrier channels would be CCₘₐₓ. After setting the current number, the process 500 returns to block 504.

If, however, the answer to block 512 is yes, then the MAC layer circuit 314 determines if the last pair has been reached (block 516) (i.e., has the process incremented through all available pairs). If the answer to block 516 is yes, then PREV_CC_CNT=CC_CNT (block 518) and the process moves to block 514.

If, however, the answer to block 516 is no, then the MAC layer circuit 314 increments the pair_index to next, sets the PREV_CC_CNT=CC_CNT, and updates the UE_CNT to MAU [pair_index] and CC_CNT to NOC [pair_index] (block 520). The process returns to block 512 after determining NOA (block 522).

Aspects of the present disclosure are well suited for use in a radio node in a WCS. Accordingly, additional details about a WCS are provided below. While such is not central to the present disclosure, it is included so that the context of the present disclosure is appreciated.

FIG. 8 is a schematic diagram of an exemplary WCS 800 that can include one or more RAN systems implemented according to a RAN standard (e.g., O-RAN standard), and may include radio node 300. The WCS 800 supports both legacy 4G LTE, 4G/5G non-standalone (NSA), and 5G standalone communications systems. As shown in FIG. 8, a centralized services node 802 (which can be a CU described above) is provided that is configured to interface with a core network to exchange communications data and distribute the communications data as radio signals to remote units, which can be the RUs described above. In this example, the centralized services node 802 is configured to support distributed communications services to a mmWave radio node 804 (e.g., radio node 300). While mmWave is specifically contemplated, the present disclosure also works for radio nods using 5G FR1. The mmWave radio node 804 is an example of a wireless device that can be configured to selectively control whether received transmit channels are transmitted through an antenna array. Although only one mmWave radio node 804 is shown in FIG. 8, it should be appreciated that the WCS 800 can be configured to include additional mmWave radio nodes 804 (or sub6 radio nodes), as needed. The functions of the centralized services node 802 can be interfaced with a 4G services node 808 through an x2 interface 806 to provide 4G/5G dual connectivity services. The centralized services node 802 can also include one or more internal radio nodes that are configured to be interfaced with a DU 810 (which can be a virtual DU and/or a DU described above) to distribute communications signals (e.g., communications channels) to one or more O-RAN RUs 812 that are configured to be communicatively coupled through an O-RAN interface 814. The O-RAN RUs 812 are another example of a wireless device that can be configured to selectively control whether received transmit channels are transmitted through an antenna array. The O-RAN RUs 812 are each configured to communicate downlink and uplink communications signals in the coverage cell(s) 801.

The centralized services node 802 can also be interfaced with a DCS 815 through an x2 interface 816. Specifically, the centralized services node 802 can be interfaced with a digital baseband unit (BBU) 818 in the DCS that can provide a digital signal source to the WCS 800 through a digital routing unit (DRU) 822. The digital BBU 818 may be configured to provide a signal to provide electrical downlink communications signals 820D (electrical downlink communications signals 820D can include downlink channels) to the DRU 822 as part of a digital DAS. The digital BBU 818 may be configured to include a neutral host agent 823 may be provided that is configured to transparently interface a shared RU(s) to a RAN according to a RAN standard (e.g., O-RAN standard). The DRU 822 is configured to split and distribute the electrical downlink communications signals 820D to different types of remote wireless devices, including a low-power remote unit (LPR) 824, a radio antenna unit (dRAU) 826, a mid-power remote unit (dMRU) 828, and/or a high-power remote unit (dHRU) 830. The DRU 822 is also configured to combine electrical uplink communications signals 820U (electrical uplink communications signals 820U can include uplink channels) received from the LPR 824, the dRAU 826, the dMRU 828, and/or the dHRU 830 and provide the combined electrical uplink communications signals 820U to the digital BBU 818. The digital BBU 818 is also configured to interface with a third-party central unit 832 and/or an analog source 834 through a radio frequency (RF)/digital converter 836.

The DRU 822 may be coupled to the LPR 824, the dRAU 826, the dMRU 828, and/or the dHRU 830 via an optical fiber-based communication medium 838. In this regard, the DRU 822 can include a respective electrical-to-optical (E/O) converter 840 and a respective optical-to-electrical (O/E) converter 842. Likewise, each of the LPR 824, the dRAU 826, the dMRU 828, and the dHRU 830 can include a respective E/O converter 844 and a respective O/E converter 846.

The E/O converter 840 at the DRU 822 is configured to convert the electrical downlink communications signals 820D into optical downlink communications signals 848D for distribution to the LPR 824, the dRAU 826, the dMRU 828, and/or the dHRU 830 via the optical fiber-based communications medium 838. The O/E converter 850 at each of the LPR 824, the dRAU 826, the dMRU 828, and/or the dHRU 830 is configured to convert the optical downlink communications signals 848D back to the electrical downlink communications signals 848D. The E/O converter 844 at each of the LPR 824, the dRAU 826, the dMRU 828, and the dHRU 830 is configured to convert the electrical uplink communications signals 848U into optical uplink communications signals 848U. The O/E converter 842 at the DRU 822 is configured to convert the optical uplink communications signals 848U back to the electrical uplink communications signals 848U.

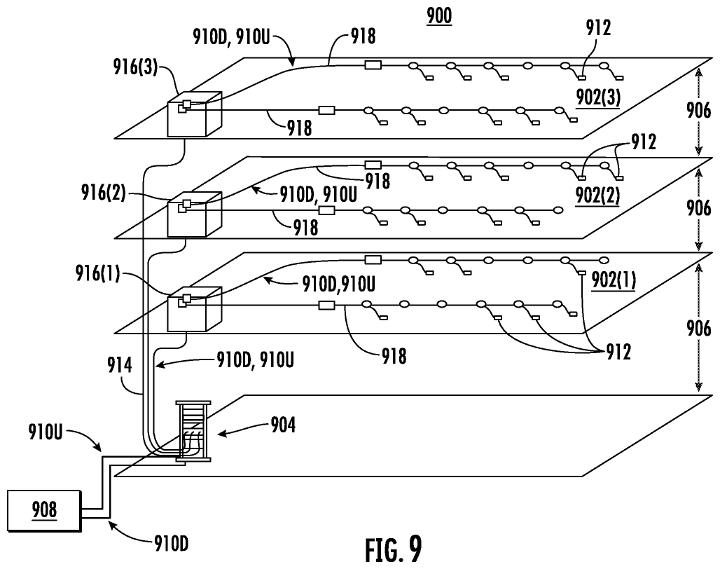

FIG. 9 is a partial schematic cut-away diagram of an exemplary building infrastructure 900 that includes an exemplary RAN system, wherein the RAN system includes multiple RANs 904 implemented according to a RAN standard (e.g., O-RAN standard). The building infrastructure 900 in this embodiment includes a first (ground) floor 902(1), a second floor 902(2), and a third floor 902(3). The floors 902(1)-902(3) are serviced by one or more RANs 904 to provide antenna coverage areas 906 in the building infrastructure 900. The RANs 904 are communicatively coupled to a core network 908 to receive downlink communications signals 910D (downlink communications signals 910D can include downlink channels) from the core network 908. The RANs 904 are communicatively coupled to a respective plurality of RUs 912 to distribute the downlink communications signals 910D to the RUs 912 and to receive uplink communications signals 910U (uplink communications signals 910U can include uplink channels) from the RUs 912, as previously discussed above. Any RU 912 can be shared by any of the multiple RANs 904. A neutral host agent 920 may be provided that is configured to transparently interface a shared RU(s) 912 to the RAN 904 according to a RAN standard (e.g., O-RAN standard).

The downlink communications signals 910D and the uplink communications signals 910U communicated between the RANs 904 and the RUs 912 are carried over a riser cable 914. The riser cable 914 may be routed through interconnect units (ICUs) 916(1)-916(3) dedicated to each of the floors 902(1)-902(3) that route the downlink communications signals 910D and the uplink communications signals 910U to the RUs 912 and also provide power to the RUs 912 via array cables 918.

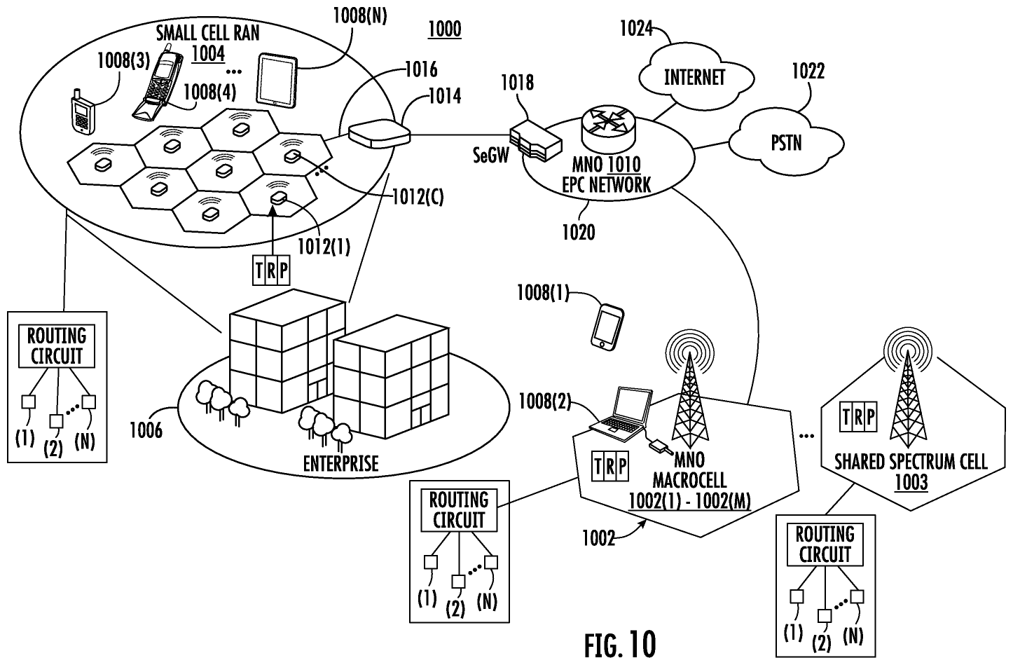

FIG. 10 is a schematic diagram of an exemplary mobile telecommunications RAN system 1000 (also referred to as “RAN system 1000”), wherein the RAN system 1000 includes multiple RANs implemented according to a RAN standard (e.g., O-RAN standard).

In this regard, RAN system 1000 includes exemplary macrocell RANs 1002(1)-1002(M) (“macrocells 1002(1)-1002(M)”) and an exemplary small cell RAN 1004 located within an enterprise environment 1006 and configured to service mobile communications between a user mobile communications device 1008(1)-1008(N) to a mobile network operator (MNO) 1010. A serving RAN for the user mobile communications devices 1008(1)-1008(N) is a RAN or cell in the RAN in which the user mobile communications devices 1008(1)-1008(N) have an established communications session with the exchange of mobile communications signals for mobile communications. Thus, a serving RAN may also be referred to herein as a serving cell. For example, the user mobile communications devices 1008(3)-1008(N) in FIG. 10 are being serviced by the small cell RAN 1004, whereas the user mobile communications devices 1008(1) and 1008(2) are being serviced by the macrocell 1002. The macrocell 1002 is an MNO macrocell in this example. The macrocell 1002 can be or include a wireless device(s) that can be configured to selectively control whether received transmit channels are transmitted through an antenna array of the wireless device. However, a shared spectrum RAN 1003 (also referred to as “shared spectrum cell 1003”) includes a macrocell in this example and supports communications on frequencies that are not solely licensed to a particular MNO, such as CBRS for example, and thus may service user mobile communications devices 1008(1)-1008(N) independent of a particular MNO. The macrocell 1002 can be or include a wireless device(s) that can be configured to selectively control whether received transmit channels are transmitted through an antenna array of the wireless device. The macrocell 1002 can be a wireless device that can be configured to selectively control whether received transmit channels are transmitted through an antenna array of the wireless device. For example, the shared spectrum cell 1003 may be operated by a third party that is not an MNO and wherein the shared spectrum cell 1003 supports CBRS. The MNO macrocell 1002, the shared spectrum cell 1003, and the small cell RAN 1004 may be neighboring radio access systems to each other, meaning that some or all can be in proximity to each other such that a user mobile communications device 1008(3)-1008(N) may be able to be in communications range of two or more of the MNO microcell(s) 1002, the shared spectrum cell 1003, and the small cell RAN 1004 depending on the location of the user mobile communications devices 1008(3)-1008(N).

In FIG. 10, the RAN system 1000 in this example is arranged as an LTE system as described by the Third Generation Partnership Project (3GPP) as an evolution of the GSM/UMTS standards (Global System for Mobile Communication/Universal Mobile Telecommunications System). It is emphasized, however, that the aspects described herein may also be applicable to other network types and protocols. The RAN system 1000 includes the enterprise environment 1006 in which the small cell RAN 1004 is implemented. The small cell RAN 1004 includes a plurality of small cell radio nodes 1012(1)-1012(C), which are wireless devices that can be configured to selectively control whether received transmit channels are transmitted through an antenna array of the wireless devices. Each small cell radio node 1012(1)-1012(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 10, the small cell RAN 1004 includes one or more service nodes (represented as a single services node 1014) that manage and control the small cell radio nodes 1012(1)-1012(C). In alternative implementations, the management and control functionality may be incorporated into a radio node, distributed among nodes, or implemented remotely (i.e., using infrastructure external to the small cell RAN 1004). The small cell radio nodes 1012(1)-1012(C) are coupled to the services node 1014 over a direct or local area network (LAN) connection 1016 as an example, typically using secure IPsec tunnels. The small cell radio nodes 1012(1)-1012(C) can include multi-operator radio nodes. A neutral host agent device could be provided between the services node 1014 and the small cell radio nodes 1012(1)-1012(C) to transparently manage communications between the services node 1014 and shared small cell radio nodes 1012(1)-1012(C). The services node 1014 aggregates voice and data traffic from the small cell radio nodes 1012(1)-1012(C) and provides connectivity over an IPsec tunnel to a security gateway (SeGW) 1018 in a network 1020 (e.g., evolved packet core (EPC) network in a 4G network, or 5G Core in a 5G network) of the MNO 1010. The network 1020 is typically configured to communicate with a public switched telephone network (PSTN) 1022 to carry circuit-switched traffic, as well as for communicating with an external packet-switched network such as the Internet 1024.

The RAN system 1000 also generally includes a node (e.g., eNodeB or gNodeB) base station, or “macrocell” 1002. The radio coverage area of the macrocell 1002 is typically much larger than that of a small cell, where the extent of coverage often depends on the base station configuration and the surrounding geography. Thus, a given user mobile communications device 1008(3)-1008(N) may achieve connectivity to the network 1020 (e.g., EPC network in a 4G network, or 5G Core in a 5G network) through either a macrocell 1002 or small cell radio node 1012(1)-1012(C) in the small cell RAN 1004 in the RAN system 1000.

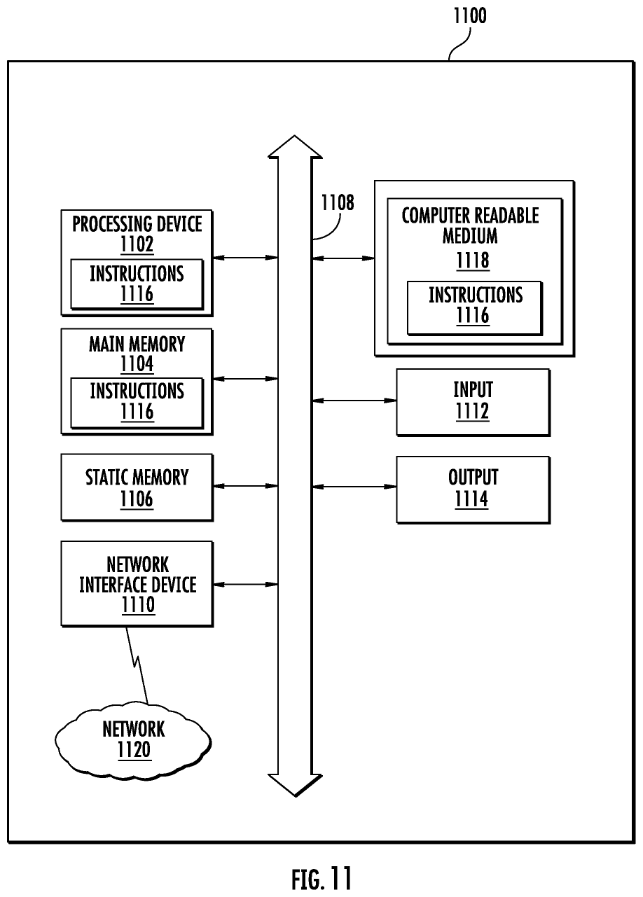

It should be appreciated that various elements within the WCS may include a computer system 1100, such as that shown in FIG. 11, to carry out their functions and operations. With reference to FIG. 11, the computer system 1100 includes a set of instructions for causing the multi-operator radio node component(s) to provide its designed functionality and the circuits discussed above. The multi-operator radio node component(s) may be connected (e.g., networked) to other machines in a LAN, an intranet, an extranet, or the Internet. The multi-operator radio node component(s) may operate in a client-server network environment or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1100 in this embodiment includes a processing circuit or processor 1102 (which may be, for example, the control circuit of the CSC), a main memory 1104 (e.g., read-only memory (ROM), flash memory, dynamic random access memory (DRAM) such as synchronous DRAM (SDRAM), etc.), and a static memory 1106 (e.g., flash memory, static random access memory (SRAM), etc.), which may communicate with each other via a data bus 1108. Alternatively, the processing circuit 1102 may be connected to the main memory 1104 and/or static memory 1106 directly or via some other connectivity means. The processing circuit 1102 may be a controller, and the main memory 1104 or static memory 1106 may be any type of memory.

The processing circuit 1102 represents one or more general-purpose processing circuits such as a microprocessor, central processing unit, or the like. More particularly, the processing circuit 1102 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1102 is configured to execute processing logic in instructions 1116 for performing the operations and steps discussed herein.

The computer system 1100 may further include a network interface device 1110. The computer system 1100 also may or may not include an input 1112 to receive input and selections to be communicated to the computer system 1100 when executing instructions 1116. The computer system 1100 also may or may not include an output 1114, including, but not limited to, a display, a video display unit (e.g., a liquid crystal display (LCD) or a cathode ray tube (CRT)), an alphanumeric input device (e.g., a keyboard), and/or a cursor control device (e.g., a mouse).

The computer system 1100 may or may not include a data storage device that includes instructions 1116 stored in a computer-readable medium 1118. The instructions 1116 may also reside, completely or at least partially, within the main memory 1104 and/or within the processing circuit 1102 during execution thereof by the computer system 1100, the main memory 1104, and the processing circuit 1102 also constituting the computer-readable medium 1118. The instructions 1116 may further be transmitted or received over a network 1120 via the network interface device 1110.

While the computer-readable medium 1118 is shown in an exemplary embodiment to be a single medium, the term “computer-readable medium” should be taken to include a single medium or multiple media (e.g., a centralized or distributed database and/or associated caches and servers) that store the one or more sets of instructions 1116. The term “computer-readable medium” shall also be taken to include any medium that is capable of storing, encoding, or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium, but excludes carrier wave signals.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product or software that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read-only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware and may reside, for example, in Random Access Memory (RAM), flash memory, Read-Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modification combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A radio node comprising:
an interface configured to communicate wirelessly with user equipment; and
a control circuit coupled to the interface and configured to:
evaluate a number of active user equipment; and
throttle carrier channel scheduling based on the number of active user equipment.

2. The radio node of claim 1, wherein the control circuit configured to evaluate the number of active user equipment is configured to determine that the user equipment is active when there is an uplink scheduling request from the user equipment.

3. The radio node of claim 1, wherein the control circuit comprises a scheduling module configured to schedule carrier channels based on throttling and user equipment requests.

4. The radio node of claim 3, wherein the scheduling module is configured to determine if a number of active user equipment has changed.

5. The radio node of claim 3, wherein the scheduling module is configured to reduce throttling carrier channel scheduling when the number of active user equipment falls below a threshold.

6. The radio node of claim 1, wherein the control circuit is configured to increase throttling the carrier channel scheduling when the number of active user equipment exceeds a threshold.

7. The radio node of claim 1, wherein the radio node comprises a radio unit (RU) and a distributed unit (DU) and the DU comprises the control circuit.

8. The radio node of claim 1, wherein the control circuit configured to evaluate the number of active user equipment is configured to determine that the user equipment is active when there are data transmissions in a downlink direction to the user equipment.

9. A method of adjusting carrier channels comprising:
determining a number of active user equipment associated with a radio node; and
throttling carrier channel scheduling when the number of active user equipment exceeds a threshold.

10. The method of claim 9, wherein determining the number of active user equipment comprises evaluating whether an uplink request or downlink data transmission is present.

11. The method of claim 9, further comprising reducing carrier channel throttling when the number of active equipment falls below the threshold.

12. The method of claim 11, wherein reducing carrier channel throttling comprises resuming scheduling a carrier channel.

13. The method of claim 9, wherein throttling comprises using a scheduling module to omit scheduling of one or more carrier channels.

14. The method of claim 9, further comprising assigning a carrier channel number and a user equipment threshold to a pair.

15. The method of claim 14, wherein the user equipment threshold comprises the threshold.

16. The method of claim 9, further comprising applying a greater throttle to the carrier channel scheduling when the user equipment exceeds a second threshold.

17. A wireless communication system comprising:
a radio node comprising:
an interface configured to communicate wirelessly with user equipment; and
a control circuit coupled to the interface and configured to:
evaluate a number of active user equipment; and
throttle carrier channel scheduling based on the number of active user equipment.
